(19) United States
(12) Patent Application Publication
(10) Pub. No.: US 2012/0063279 A1
(43) Pub. Date: Mar. 15, 2012

(54) RECORDING MEDIUM, DATA RECORDING/REPRODUCING METHOD, AND DATA RECORDING/REPRODUCING APPARATUS

(76) Inventors: Yong Cheol Park, Seoul (KR); Hyug Jin Kwon, Seoul (KR); Sung Hoon Kim, Seoul (KR)

(21) Appl. No.: 13/319,967

(22) PCT Filed: May 3, 2010
(86) PCT No.: PCT/KR2010/002787

§ 371 Date: Nov. 10, 2011

(30) Foreign Application Priority Data
May 11, 2009 (KR) 10-2009-0040680

(51) Int. Cl. G11B 7/007

(52) U.S. Cl. 369/30.03; G9B/7.029

(57) ABSTRACT

A recording medium, a data recording/reproducing method and a data recording/reproducing apparatus are disclosed. A recording medium comprises a data zone where user data are recorded; an inner zone located at an inner circumference of the data zone; and an outer zone located at an outer circumference of the data zone, wherein the data zone includes at least one spare area, and at least one of the inner zone and the outer zone includes at least one disc management area, the disc management area including: defect management information of the recording medium; general management information including information of the defect management information; and address information of the spare area that can be used as a defective replacement cluster, the general management information including address information per cluster of the disc management area where the defect management information is recorded. According to the recording medium, the data recording/reproducing method and the data recording/reproducing apparatus of the present invention, the defect occurring in the recording medium can be managed more efficiently.

### TECHNICAL FIELD

The present invention relates to a data recording/reproducing method and a data recording/reproducing apparatus, and more particularly, to a method and apparatus of managing a defect occurring in a recording medium during data recording/reproduction and a recording medium that can record/reproduce data using the method and apparatus.

### BACKGROUND ART

Recently, with the rapid development of technology, a recording medium having high capacity has appeared. Examples of such a recording medium include a compact disc (CD) and a digital versatile disc (DVD). Also, in addition to such recording mediums, there are next generation recording media with more remarkably increased capacity. Examples of the next generation recording media include a Blu-ray disc and a near field recording medium. Also, in order to increase capacity of the recording medium, a multilayered recording medium having a plurality of recording layers has appeared. In the middle of recording/reproducing data using such a recording medium having high capacity or multilayered recording medium, when a defect occurs in the recording medium, its management is required. Accordingly, a method for managing a defect occurring in a recording medium more efficiently will be required.

### DISCLOSURE OF INVENTION

### Technical Problem

Accordingly, the present invention is directed to a recording medium, a data recording/reproducing method and a data recording/reproducing apparatus, which substantially obviate one or more problems due to limitations and disadvantages of the related art.

An object of the present invention is to provide a method and apparatus of most efficiently managing a defect occurring in a recording medium during data recording/reproduction.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

### Solution to Problem

To achieve these objects and other advantages and in accordance with the purpose of the invention, as embodied and broadly described herein, a recording medium according to the present invention comprises a data zone where user data are recorded; an inner zone located at an inner circumference of the data zone; and an outer zone located at an outer circumference of the data zone, wherein the data zone includes at least one spare area, and at least one of the inner zone and the outer zone includes at least one disc management area, the disc management area including: defect management information of the recording medium; general management information including information of the defect management information; and address information of the spare area that can be used as a defective replacement cluster, the general management information including address information per cluster of the disc management area where the defect management information is recorded.

The defect management information includes a defect list entry where cluster address information of the spare area determined as a defective cluster is recorded.

The address information of the spare area that can be used as a defective replacement cluster is recorded in a header of the defect management information.

The address information of the spare area that can be used as a defective replacement cluster is recorded in the general management information.

The address information of the spare area that can be used as a defective replacement cluster includes cluster address information per spare area.

The address information of the spare area that can be used as a defective replacement cluster includes cluster address information of one spare area.

The address information is a physical sector number (PSN).

The recording medium is a re-recordable recording medium.

The recording medium includes three or more recording layers.

In another aspect of the present invention, a data recording method comprises recording address information of a spare area of a recording medium, which can be used as a defective replacement cluster of the recording medium, in a disc management area of the recording medium; and recording general management information in the disc management area of the recording medium, the general management information including address information per cluster of the disc management area where defect management information of the recording medium is recorded.

In still another aspect of the present invention, a data reproducing method comprises reading address information of a spare area of a recording medium, which is recorded in at least one disc management area included in the recording medium and can be used as a defective replacement cluster of the recording medium; reading general management information including address information per cluster of the disc management area where defect management information of the recording medium is recorded; and reproducing data of the recording medium in accordance with the defect management information.

In further still another aspect of the present invention, a data recording apparatus comprises a pickup recording data in a recording medium; and a controller controlling the pickup to record address information of a spare area of the recording medium, which can be used as a defective replacement cluster of the recording medium, and general management information including address information per cluster of the disc management area where defect management information of the recording medium is recorded, in a disk management area of the recording medium.

In further still another aspect of the present invention, a data reproducing apparatus comprises a pickup reading data of a recording medium; and a controller controlling the pickup to record address information of a spare area of the recording medium, which is recorded in at least one disc management area included in the recording medium and can be used as a defective replacement cluster of the recording medium, read general management information including address information per cluster of the disc management area where defect management information of the recording medium is recorded, and reproduce data of the recording medium in accordance with the defect management information.

It is to be understood that the advantages that can be obtained by the present invention are not limited to the aforementioned advantages and other advantages which are not mentioned will be apparent from the following description to the person with an ordinary skill in the art to which the present invention pertains.

### Advantageous Effects of Invention

According to the data recording/reproducing method and the data recording/reproducing apparatus of the present invention, a size of defect management information of a recording medium can be reduced. Also, since normal management information and defect management information can be located together in a recording layer, the time for reading defect management information can be reduced.

### BRIEF DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic diagram illustrating a structure of a recording medium according to the embodiment of the present invention;

FIG. 2 is a schematic view illustrating a structure of a defect list (DFL) according to the embodiment of the present invention;

FIG. 3 is a schematic view illustrating a structure of a defect list (DFL) entry according to the embodiment of the present invention;

FIG. 4 is a schematic view illustrating a SPR-BA type defect list (DFL) entry according to the embodiment of the present invention;

FIG. 5 and FIG. 6 are schematic views illustrating a defect list (DFL) entry when spare areas are enlarged in accordance with the embodiment of the present invention;

FIG. 7 and FIG. 8 are schematic views illustrating a defect list (DFL) entry when spare areas are reduced in accordance with the embodiment of the present invention;

FIG. 9 to FIG. 11 are schematic views illustrating address information of spare areas, which are recorded in a disc management area (DMA) and can be used as defective replacement clusters, in accordance with the embodiment of the present invention;

FIG. 12 is a schematic view illustrating a disc definition structure (DDS) according to the embodiment of the present invention;

FIG. 13 and FIG. 14 are schematic views illustrating a disc management area (DMA) where a defect list (DFL) is recorded in accordance with the embodiment of the present invention; and

FIG. 15 is a block diagram illustrating a data recording/reproducing apparatus according to the embodiment of the present invention.

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts.

The terms used in the present invention are selected from generally known and used terms considering their functions in the present invention. However, in special case, the terms mentioned in the description of the present invention may be selected by the applicant at his or her discretion, the detailed meanings of which are described in relevant parts of the description herein. Accordingly, the terms used herein should be understood not simply by the actual terms used but by the meaning lying within and the description disclosed herein.

In the present invention, a recording medium means every medium where data are recorded or can be recorded. For example, the recording medium is a comprehensive term of all media regardless of recording type, such as disc and magnetic tape. Hereinafter, for convenience of description, disc, especially, Blu-ray disc (BD) will be described as a recording medium. However, it will be apparent that technical spirits of the present invention are applicable to other recording media.

Also, in the present invention, among blu-ray discs (BD), a re-recordable type (BD-RE) recording medium will be described. However, it will be apparent that technical spirits of the present invention are applicable to other type recording media.

Furthermore, the recording medium of the present invention is configured in a certain unit. For example, the recording medium can include a unit called cluster. The cluster can include a data frame which is a lower unit. For example, one cluster may include 32 data frames. However, name of each unit and the number of units may be varied depending on types of the recording medium.

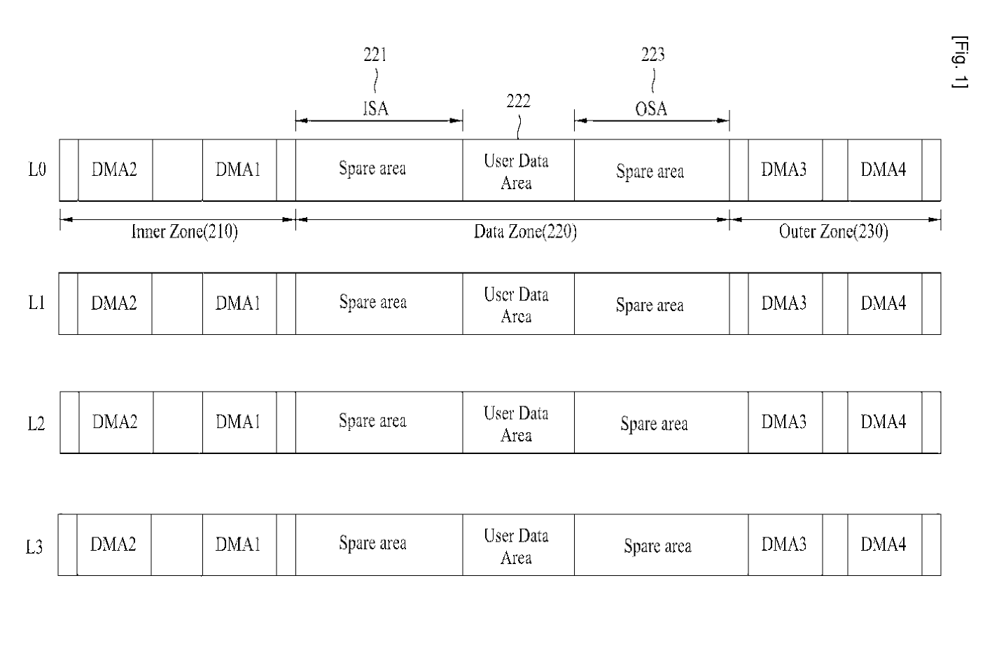

FIG. 1 is a schematic diagram illustrating a structure of a recording medium 10 according to the embodiment of the present invention.

FIG. 1 illustrates a quadruple layer recording medium 10 of four layers L0, L1, L2, and L3. However, the present invention is not limited to the quadruple layer recording medium but applicable to every recording medium having two layers or more as well as a single layer. Since the respective layers can be configured in the same structure, the first layer L0 will be described herein.

The recording medium 10 of the present invention includes an inner zone 210, an outer zone 230, and a data zone 220.

The inner zone 210 is located at the inner circumference of the recording medium 10, and the outer zone 230 is located at the outer circumference of the recording medium 10, wherein various kinds of information for controlling the recording medium 10 is stored in the outer zone 230. And, the inner zone 210 and the outer zone 230 include a disc management area (DMA).

Data desired by a user are stored in the data zone 220. A part surrounded by the inner zone 210 and the outer zone 230 on the recording medium 10 becomes the zone in which data are actually recorded. The data zone 220 can include an inner spare area (ISA) 221, an outer spare area (OSA) 223, and a user data area 222. FIG. 1 illustrates two spare areas (inner spare area and outer spare area). However, arrangement and the number of spare areas are only examples, and various modifications can be made in the spare areas within the range that does not depart from spirits of the present invention. In view of features of a recording medium that can be recorded again, the spare areas 221 and 223 can be varied in their sizes. In the case that the spare areas 221 and 223 are enlarged, a part of the user data area 222 adjacent to the spare areas 221 and 223 is changed to the spare areas 221 and 223. In the case that the spare areas 221 and 223 are reduced, a part of the spare areas 221 and 223 adjacent to the user data area 222 is changed to the user data area 222.

The disc management area DMA is included in the inner zone 210 and the outer zone 230 of the recording medium 10. Also, as shown in FIG. 1, the disc management area DMA can include four disc management areas DMA1, DMA2, DMA3 and DMA4 and 32 clusters. However, the arrangement and the number of disc management areas DMAs shown in FIG. 1 are only example, and various modifications can be made in the arrangement and the number of disc management areas within the range that does not depart from the spirits of the present invention.

Same information can be recorded in each of the disc management areas DMA1, DMA2, DMA3, and DMA4. However, in respect of location of each disc management area, different kinds of information can be recorded in the disc management areas. Also, in the multi layered recording medium 10, same information can be recorded in the disc management area (DMA). Alternatively, user data may be recorded in the disc management area.

General management information such as structural information of the recording medium 10 and defect management information such as a defect list can be recorded in the disc management area (DMA). A disc definition structure (DDS) can be recorded in the general management information. A format of the recording medium 10 is recorded in the disc definition structure (DDS), and size of the spare areas 221 and 223 of the recording medium 10 and address information of the defect list (DFL) can be included in the disc definition structure (DDS).

Also, address information of clusters of the spare areas 221 and 223, which can be used as defective replacement clusters, can additionally be included in the disc definition structure (DDS). In this case, the size of the defect management information can be reduced. This will be described later.

For example, the disc definition structure (DDS) includes four clusters. The DDS can be recorded repeatedly four times in the disc management area (DMA) to prevent information recorded in the disc definition structure (DDS) from being damaged.

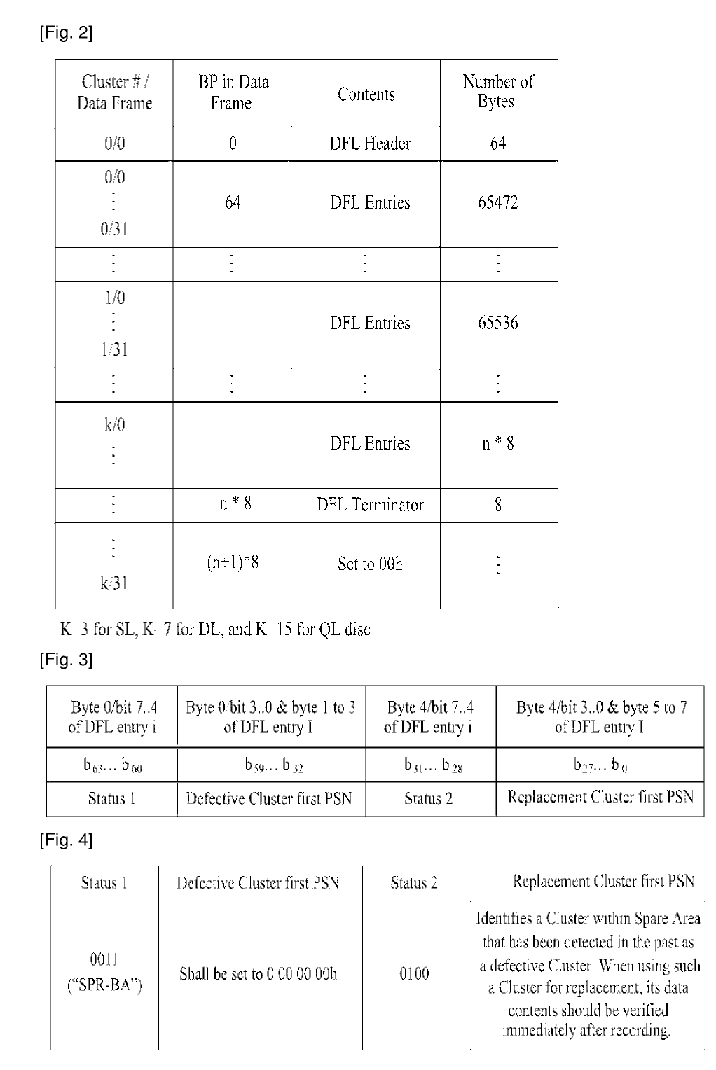

A defect list (DFL) which is defect information of the recording medium 10 can be recorded in the defect management information. FIG. 2 is a schematic view illustrating a structure of a defect list (DFL) according to the embodiment of the present invention.

A defect list (DFL) header, a defect list (DFL) entry, and a defect list (DFL) terminator are recorded in the defect list (DFL).

First of all, information of the defect list entry recorded to be adjacent to the defect list header is recorded in the defect list header. Examples of the information of the defect list entry include identifier, defect list update information, and the number of defect list entries. For example, the defect list header can be configured by size of 64 bytes.

Also, the defect list header can further include address information of clusters of the spare areas 221 and 223, which can be used as defective replacement clusters. The defect list entry is recorded to be adjacent to the defect list header, and includes information of defect occurring in the recording medium 10. Identification information (Status 1, Status 2), address information (defective cluster first PSN) of an area where defect occurs in the recording medium 10, and address information (replacement cluster first PSN) of an area recorded by replacing an area where defect occurs, can be recorded in the defect list entry. Address of the defect area or the replacement area can be configured by first physical sector number of cluster. Since one defect list entry represents one kind of defect information, if an area where defect occurs in the recording medium 10 increases, the number of defect list entries recorded in the defect list increases relatively. For example, if one defect list entry is configured by size of 8 bytes, if the area where defect occurs increases, the size of the defect list increases. If a plurality of defect list entries exist, they can be recorded continuously in adjacent to the defect list header.

Also, the defect list entry can be configured to include other information that manages defect of the recording medium 10 in addition to the aforementioned defect information. This defect list entry will be described later in detail.

If all the defect list entries are completely recorded, information indicating that recording of the defect list has ended is recorded in the defect list terminator. For example, the defect list terminator can be configured by size of 8 bytes.

If the number of layers increases in the multi layered recording medium 10, the user data areas 222 increase. Accordingly, the size of the defect list can be set in accordance with the number of layers of the recording medium 10. For example, in the single layered recording medium 10, the defect list can be configured by four (4) clusters. In the dual layered recording medium 10, the defect list can be configured by eight (8) clusters. Also, in the quadruple layered recording medium 10, the defect list can be configured by sixteen (16) clusters.

At this time, a random value can be recorded (padding) continuously in an area next to an area where the defect list terminator is recorded in the defect list which is previously set, i.e., other empty area. Herein, an example that a value 00h is recorded continuously in the other area will be described.

FIG. 3 is a schematic view illustrating a structure of a defect list (DFL) entry according to the embodiment of the present invention.

The defect list entry of FIG. 3 includes identification information (Status 1, Status 2), address information (defective cluster first PSN, hereinafter, referred to as ‘defective cluster address information’) of a cluster where defect occurs, and address information (replacement cluster first PSN, hereinafter, referred to as ‘defective replacement cluster address information’) of a cluster recorded by replacing an area where defect occurs. Accordingly, the recording medium 10 that includes the defect list entry is read, data recorded in the defective replacement cluster are read instead of data recorded in the defective cluster.

The defect list entry, as described above, can be configured to include defective cluster address information and defective replacement cluster address information. Also, the defect list entry can be configured to include other defect management information.

Type information of the defect list entry is recorded in the identification information. For example, the defect list entry can include various types, wherein the first type defect list entry is configured to include defective cluster address information and defective replacement cluster address information.

The second type defect list entry includes defective cluster address information but does not include defective replacement cluster address information.

The third type defect list entry is configured to include address information of clusters which may be checked due to the possibility of defect. The third type defect list entry can be designated as a possible bad area (PBA) type defect list entry.

The fourth type defect list entry is configured to include address information of clusters which cannot be used as a defective replacement area. The fourth type defect list entry can be designated as an unusable type defect list entry.

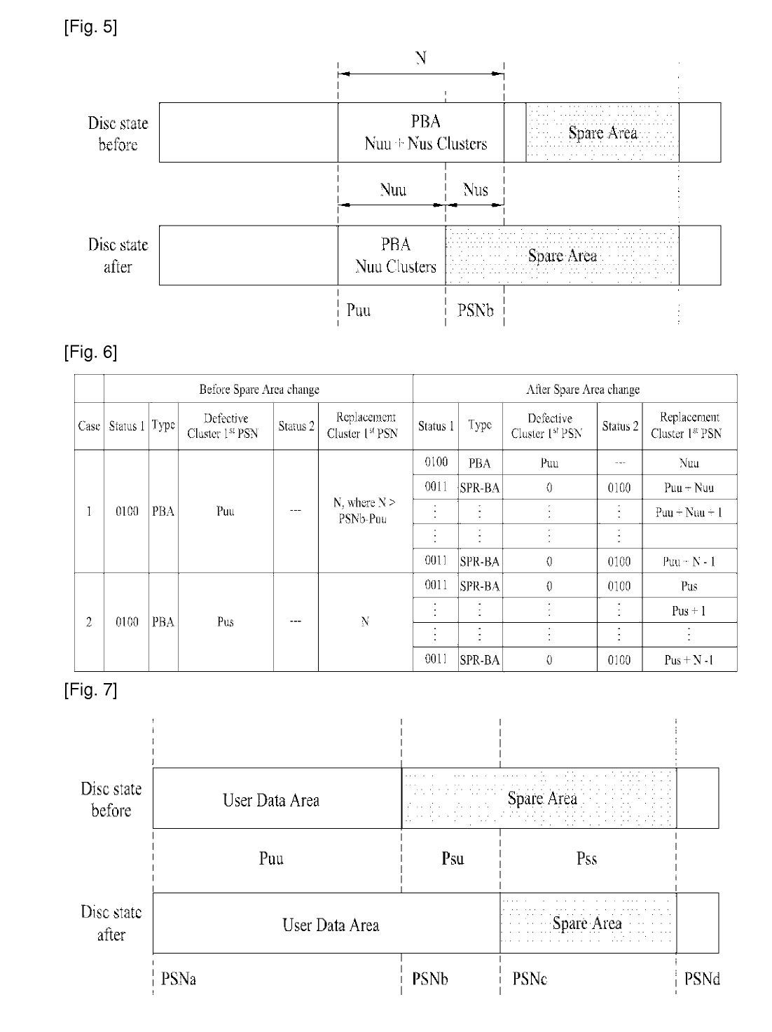

Also, the fifth type defect list entry is located in the spare areas 221 and 223 and can be used as a defective replacement area. However, the fifth type defect list entry is configured to include address information of cluster determined as a defective cluster. The fifth type defect list entry can be designated as a spare cluster-bad area (SPR-BA) type defect list entry. The SPR-BA type defect list entry will be described in detail with reference to FIG. 4.

FIG. 4 is a schematic view illustrating a structure of a SPR-BA type defect list (DFL) entry according to the embodiment of the present invention.

For example, the SPR-BA type defect list entry can be configured in such a manner that identification information (Status 1) has a value 0011h and identification information (Status 2) has a value 0100h.

A random value which is meaningless is recorded in the defective cluster address information. In the present invention, for example, a value 00h is recorded in the defective cluster address information.

Address information of clusters, which are located in the spare areas 221 and 223 of the recording medium 10, can be used as a defective replacement area but had been determined as defective clusters, is recorded in the defective replacement cluster address information.

Accordingly, in the case that the clusters recorded in the SPR-BA type defect list entry are used as defective replacement clusters, it should be verified whether data have been normally recorded in the defective replacement clusters.

In the recording medium 10 that can be recorded again, the spare areas 221 and 223 of the recording medium, which can be used as the defective replacement areas, can be configured variably. In the case that the defect list is configured by the aforementioned SPR-BA type defect list entry, the structure of the defect list can be varied due to enlargement or reduction of the spare areas 221 and 223.

FIG. 5 and FIG. 6 are schematic views illustrating a defect list (DFL) entry when spare areas 221 and 223 are enlarged in accordance with the embodiment of the present invention.

FIG. 5 illustrates a recording medium 10 that includes a user data area 222 having possibly bad areas as much as N clusters, and a recording medium 10 having a part (Nus clusters) of PBAs included in the user data area 222 and then entered as spare areas 221 and 223 due to enlargement of the spare areas 221 and 223.

FIG. 6 illustrates a defect list (DFL) of the recording medium 10 before and after the spare areas 221 and 223 are enlarged. In this case, Case 1 relates to the recording medium 10 shown in FIG. 6.

In more detail, in the recording medium 10 before the spare areas 221 and 223 are enlarged, the defect list DFL is configured by one PBA type defect list entry due to PBA included in the user data area 222. In the recording medium 10 after the spare areas 221 and 223 are enlarged, the defect list DFL is configured by one PBA type defect list entry of PBA included in the user data area 222 and SPR-BA type defect list entry of an area which has been actually PBA but entered as the spare areas 221 and 223. The PBA entered as the spare areas 221 and 223 is an area that can be used as the defective replacement cluster but is a cluster having the possibility of defect. Since the SPR-BA type defect list entry is configured per one cluster, Nus number of SPr-BA type defect list entries are recorded in the defect list DFL. Case 2 illustrates that a defect list DFL of the recording medium 10 in the case that all PBAs of the user data area 222 enter the spare areas 221 and 223, wherein every cluster information of the PBA is recorded in the SPR-BA type defect list entry. In this case, N number of SPR-BA type defect list entries are recorded in the defect list DFL.

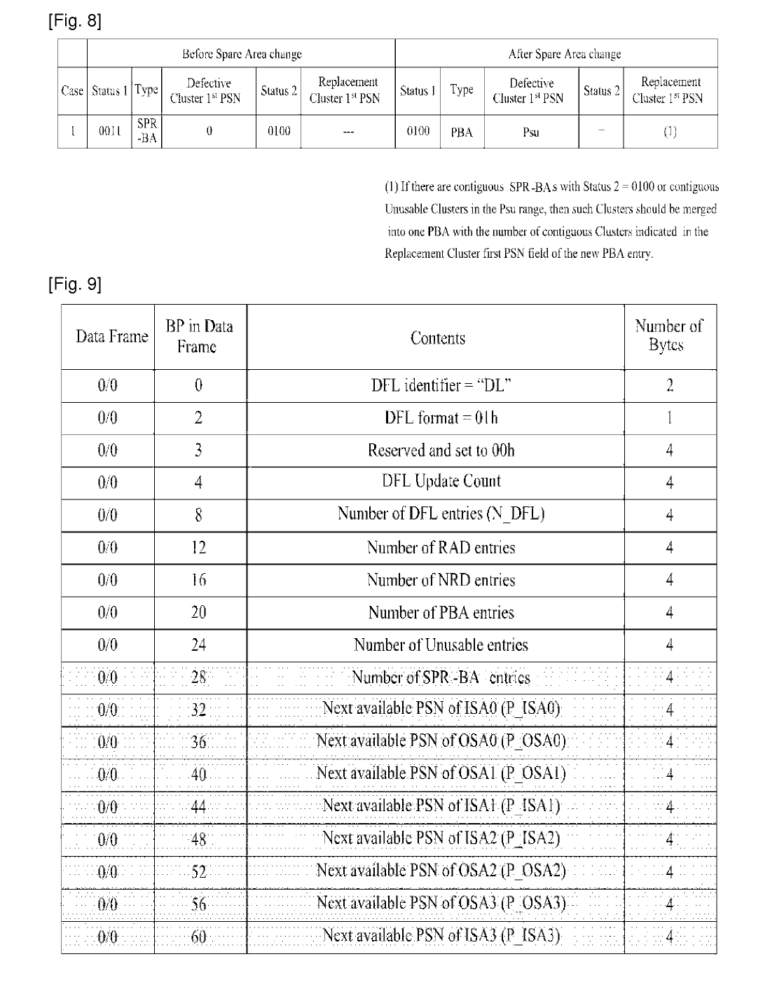

FIG. 7 and FIG. 8 are schematic views illustrating a defect list (DFL) entry when spare areas 221 and 223 are reduced in accordance with the embodiment of the present invention.

FIG. 7 illustrates the recording medium 10 having a part of the spare areas 221 and 223, which is entered as the user data area 222 due to reduction of the spare areas 221 and 223.

FIG. 8 illustrates a defect list DFL of the recording medium 10 before and after the spare areas 221 and 223 are reduced. If the cluster that can be used as the defective replacement cluster and has the possibility of defect enters the user data area 222, the cluster becomes a cluster having the possibility of defect, i.e., PBA. Accordingly, the defect list (DFL) is recorded by the SPR-BA type defect list entry while clusters are recorded by the PBA type defect list entry. Even though the unusable area that cannot be used as the defective replacement cluster enters the user data area 222, the area becomes the PBA. Therefore, the PBA type defect list entry of the area is recorded in the defect list (DFL).

As another method for managing defect information of the recording medium, address information of the spare areas 221 and 223 that can be used as the defective replacement clusters may be recorded in the disc management area (DMA). If defect occurs in the user data area 222 where data will be recorded, data are recorded in the spare areas 221 and 223 in accordance with address information of the area that can be used as the defective replacement cluster recorded in the disc management area (DMA). In the above method, the defect list entry of the defect list can be configured to include address information of all clusters of the spare areas 221 and 223 that can be used as the defective replacement clusters. However, since more defect list entries are generated if the size of the spare areas 221 and 223 becomes greater, the size of the defect list (DFL) becomes great.

FIG. 9 to FIG. 11 are schematic views illustrating address information of spare areas 221 and 223, which are recorded in a disc management area (DMA) and can be used as defective clusters, in accordance with the embodiment of the present invention.

In FIG. 9 to FIG. 11, address information (next available PSN of ISA#/OSA#/Spare area) of the spare areas 221 and 223 that can be used as the defective replacement clusters is recorded in the defect list header or the disk definition structure (DDS) not the aforementioned defect list entry. The address information of the spare areas 221 and 223 can be configured by the first physical sector number of the area that can be used as the defective replacement cluster.

FIG. 9 illustrates a structure of the defect list header where address information of the spare areas 221 and 223 that can be used as the defective replacement clusters is recorded.

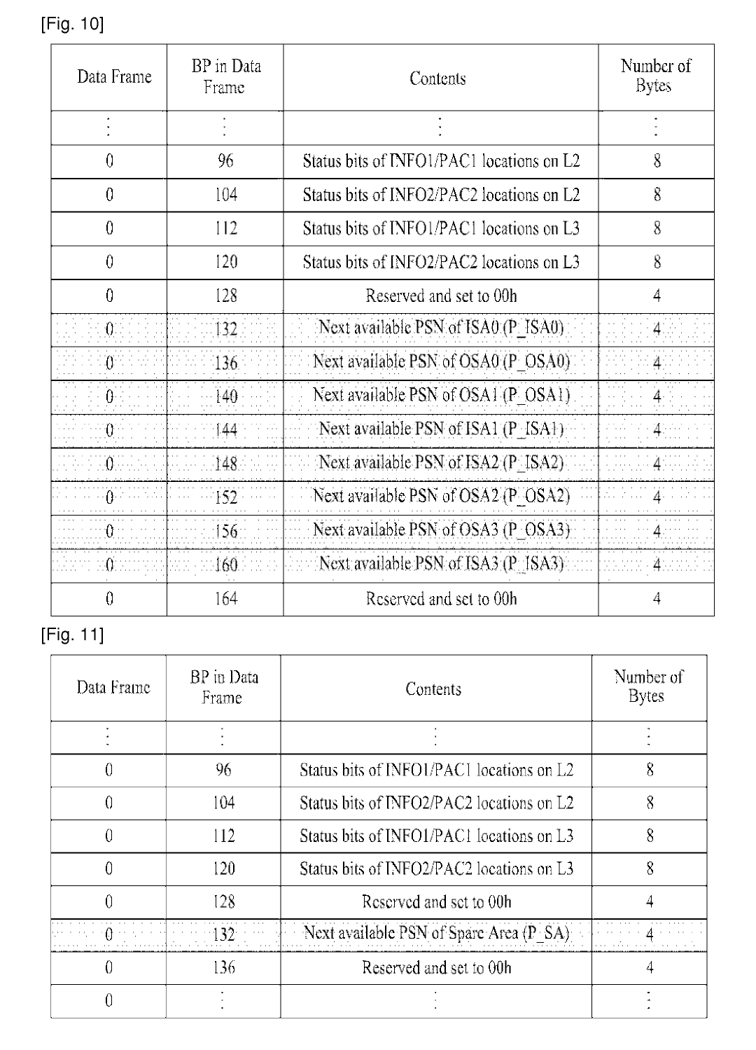

FIG. 10 illustrates the disc definition structure (DDS) where address information of the spare areas 221 and 223 that can be used as the defective replacement clusters is recorded.

In the defect list header of FIG. 9 and the disc definition structure (DDS) of FIG. 10, address information of the spare areas 221 and 223 that can be used as the defective replacement clusters is included for each of the spare areas 221 and 223. The address information of the spare areas 221 and 223 that can be used as the defective replacement clusters is recorded respectively in the spare areas 221 and 223.

In the case that the recording medium 10 having four layers includes the inner spare area 221 and the outer spare area 223 for each layer, address information of eight spare areas 221 and 223 is recorded.

If the defect list header or the disc definition structure (DDS) is configured as shown in FIG. 9 or FIG. 10, since the address information of the spare areas 221 and 223 that can be used as the defective replacement clusters is not recorded, it does not affect the size of the defect list (DFL).

Furthermore, the address information of the spare areas 221 and 223 that can be used as the defective replacement clusters can be configured by address information of one spare area (221, 223). If defect occurs in the recording medium 10, address information of the spare areas 221, 223 which will be used as the actual defective replacement clusters, is recorded.

FIG. 11 illustrates a disc definition structure (DDS) having address information of one spare area (221, 223). Although not shown, address information of one spare area (221, 223) is recorded in the defect list header in accordance with one embodiment of the present invention.

If the disc definition structure (DDS) is configured as shown in FIG. 11, only address information of the defective replacement cluster which will be used directly is recorded, whereby the defective replacement cluster can be managed with consistency.

The defect list (DFL) is recorded in the disc management area (DMA). In this case, if defect occurs in a part of the disc management area (DMA) where the defect list (DFL) is recorded, a problem occurs in a method for managing a damaged defect list (DFL).

First of all, all of the defect lists (DFLs) which are previously recorded are set as the damaged defect lists, and the defect list (DFL) is re-recorded continuously in adjacent to the area where the damaged defect list is recorded.

However, since the re-recorded defect list (DFL) can be recorded in the second layer L1 or next layer, it is located in other layer different from the first layer L1 where general management information is located. In this case, much time will be required in order that the data recording/reproducing apparatus reads the general management information of the recording medium 10 and the defect list (DFL) together.

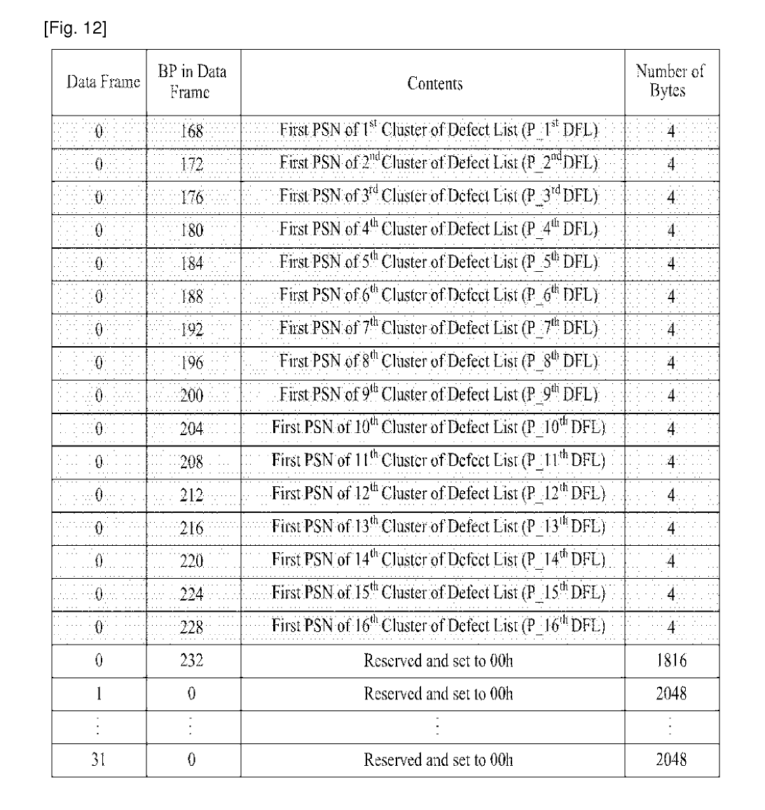

FIG. 12 is a schematic view illustrating a disc definition structure (DDS) according to the embodiment of the present invention.

The disc definition structure (DDS) includes address information (first PSN of #cluster of defect list) per cluster of the disc management area (DMA) where the defect list (DFL) is recorded. For example, the address information can be configured by the first physical sector number of the cluster.

In case of the recording medium 10 having four layers, since the defect list (DFL) can include 16 clusters, 16 kinds of cluster address information is recorded in the disc definition structure (DDS). The value 00h can be recorded in the address information of the cluster which is not used yet.

Since the recording medium 10 having the disc definition structure (DDS) of FIG. 12 has address information of each cluster where the defect list (DFL) is recorded, the defect list (DFL) does not needed to be continuously recorded in the disc management area (DMA). In other words, the defect list (DFL) can be recorded for each of clusters. Hereinafter, the embodiments according to the present invention will be described.

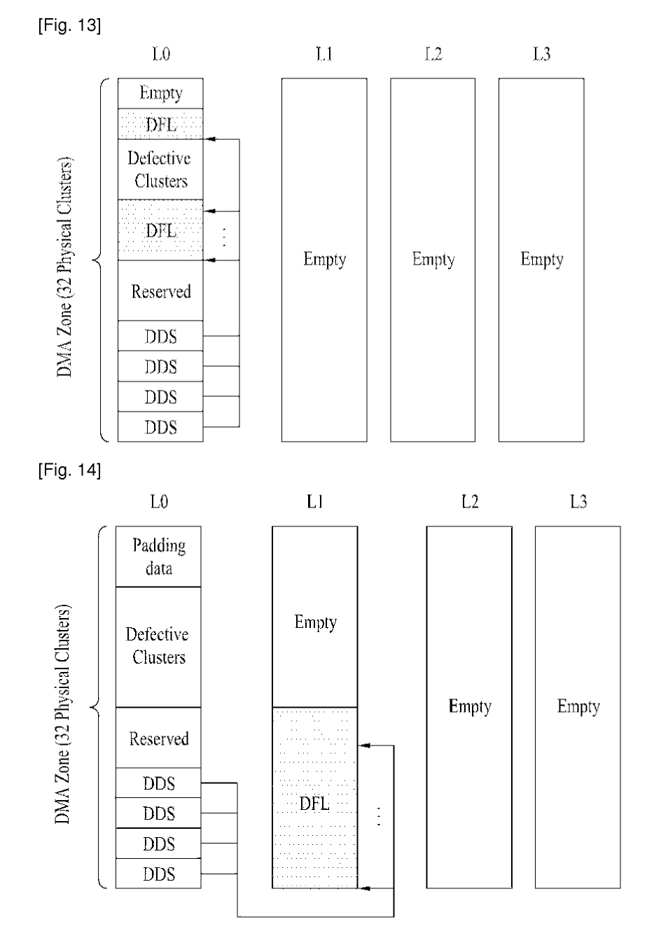

FIG. 13 and FIG. 14 are schematic views illustrating a disc management area (DMA) where a defect list (DFL) is recorded in accordance with the embodiment of the present invention.

FIG. 13 illustrates that the defect list (DFL) is recorded respectively in the disc management area (DMA) when defect occurs in a part of the disc management area (DMA) where the defect list (DFL) is recorded.

According to the disc management area (DMA) of FIG. 13, even though defect occurs in a part of the area where the defect list (DFL) is recorded, the defect list (DFL) is recorded in the first layer LO. In other words, the general management information and the defect list (DFL) are together located in the first layer L0. Accordingly, the time for reading the general management information and the defect list (DFL) together in the data recording/reproducing apparatus can be reduced.

FIG. 14 illustrates that the defect list (DFL) is recorded continuously in one layer when the defect list (DFL) is recorded respectively in a plurality of layers as defect occurs in a part of the disc management area (DMA) where the defect list (DFL) is recorded.

Since the disc definition structure (DDS) includes address information of each cluster where the defect list (DFL) is recorded, the defect list (DFL) can be recorded in a random location of the disc management area (DMA). Accordingly, in a state that the defect list (DFL) is recorded respectively in a plurality of layers as defect occurs in a part of the disc management area (DMA), a random value is padded in the disc management area (DMA) of an upper layer while the defect list (DFL) is recorded continuously in the disc management area (DMA) of a lower layer.

According to the disc management area (DMA) of FIG. 14, since the defect list (DFL) is recorded continuously in one layer, the time for reading the defect list (DFL) in the data recording/reproducing apparatus can be reduced.

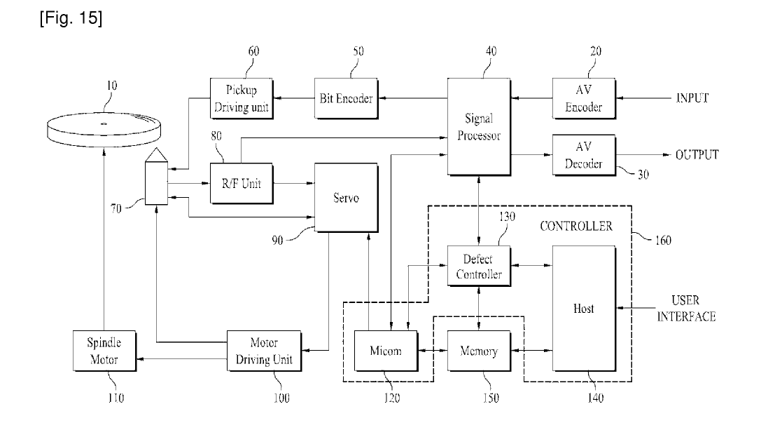

FIG. 15 is a block diagram illustrating a data recording/reproducing apparatus according to the embodiment of the present invention.

The entire configuration of the data recording/reproducing apparatus according to the present invention will be described. First of all, a pickup 70 includes a laser diode therein to record data on a surface of the recording medium 10 or read a signal reflected from the recording medium 10.

A servo 90 controls tracking and focusing operation of the pickup 70 and operation of a spindle motor 110.

A radio/frequency (R/F) unit 80 generates a focus error signal and a tracking error signal, which are signals for detecting focus deviation and track deviation of a laser beam using a signal output from the pickup 70.

The spindle motor 110 rotates a disc mounted in the data recording/reproducing apparatus.

A motor driving unit 100 drives the pickup 70 and the spindle motor 110 under the control of the servo 90.

A signal processor 40 recovers the signal received from the R/F unit 80 to a desired reproducing signal value or modulates a data signal, which is to be recorded, to a recordable format.

A bit encoder 50 converts the recording signal output from the signal processor 40 into a bit stream, and a pickup driving unit 60 converts the bit stream generated by the bit encoder 50 into an optical signal, which is to be stored in the recording medium 10.

A memory 150 temporarily stores information related to the recording medium 10 including defect information of the recording medium 10 or performs a buffer function for temporarily storing data to be recorded or reproduced in the recording medium 10.

A controller 120 is configured to control the signal processor 40, the servo 90, and the memory 150, and controls a drive, which includes structural elements, to record or reproduce data.

A defect controller 130 generates a defect list (DFL) that is defect information of the recording medium 10, and controls the controller 120 to record the defect list (DFL) in the disc management area (DMA) of the recording medium 10. The defect controller 130 can allow the defect list (DFL) to include a defect list header, a defect list entry, and a defect list terminator. The defect controller 130 records information of the defect list entry in the defect list header, wherein the defect list entry is recorded in adjacent to the defect list header. And, the defect controller 130 records address information of an area where defect occurs in the recording medium 10, a defect type, and information of an area recorded by replacing an area where defect occurs, in the defect list entry. Also, the defect controller 130 records information, which indicates that recording of the defect list entry has been terminated, in the defect list terminator.

The defect controller 130 controls the pickup 70 to record the disc definition structure (DDS) in the disc management area (DMA) of the recording medium 10, wherein the disc definition structure includes address information per cluster of the disc management area (DMA) where the defect list (DFL) is recorded.

The defect controller 130 records the defect list entry in the defect list (DFL), wherein cluster address information of the spare areas 221 and 223 determined as defect clusters is recorded in the defect list entry. The defect controller 130 records address information of the spare areas 221 and 223 in the header of the defect list (DFL) or the disc definition structure (DDS), wherein the spare areas 221 and 223 can be used as clusters that replace the defect clusters.

The defect controller 130 allows address information of the spare areas 221 and 223 that can be used as defective replacement clusters to include either cluster address information per spare areas 221 and 223 or cluster address information of one spare area 221 or 223 in the recording medium 10 that includes a plurality of spare areas 221 and 223.

Also, the defect controller 130 controls the pickup 70 to read address information of the spare areas 221 and 223 of the recording medium, which are recorded in at least one disc management area (DMA) included in the recording medium 10 and can be used as the defective replacement clusters of the recording medium 10, read the disc definition structure (DDS) that includes address information per cluster of the disc management area (DMA) where the defect list (DFL) is recorded, and reproduce data of the recording medium 10 in accordance with the defect list (DFL).

Also, the defect controller 130 replaces data of a cluster where defect occurs when data of the recording medium 10 are reproduced, with new data by using the defect list (DFL) of the recording medium 10 read out through the pickup 70.

The defect controller 130 is shown, but not limited to, by one element in the present invention. The functions of the defect controller 130 may be performed by several elements in conjunction with one another. The defect controller 130 can be integrated into the controller 120 and/or a host 140. Also, the defect controller 130 may additionally be connected with a drive that includes the signal processor 40, the bit encoder 50, the pickup driving unit 60, the pickup 70, the servo 90, the motor driving unit 100, the spindle motor 110, the controller 120, and the memory 150, whereby the defect controller 130 may be implemented to be updated.

The host 140 serves to control all elements within the data recording/reproducing apparatus, and controls recording or reproduction of the recording medium 10 by interfacing with a user.

Specifically, the host 140 transfers a command, which allows the data recording/reproducing apparatus of the present invention to perform a specific function, to the controller 120, and the controller 120 controls elements, which are configured within the data recording/reproducing apparatus in conjunction with one another, in accordance with the command. The controller 120 and the host 140 may be operated separately. Alternatively, the functions of the controller 120, the defect controller 130 and the host 140 may be integrated into one control unit.

The host 140 could be a main controller of a computer, server, audio device or vide device. Namely, the data recording/reproducing apparatus of the present invention could be either an optical drive provided to a personal computer (PC), or a player which is not mounted in the PC.

Accordingly, the data recording/reproducing apparatus of the present invention can be applied to both an optical drive mounted into a PC and a player used as a separate product.

Also, an AV encoder 20 converts an input signal into a signal of a specific format that can be recorded in the recording medium 10 and transmits the signal to the signal processor 40, so as to record data in the recording medium 10. For example, the AV encoder 20 can encode the input signal into MPEG format signal. The signal processor 40 converts the signal encoded from the AV encoder 20 into a format that can be recorded in the recording medium 10 by adding an error correction code (ECC) thereto and transfers the converted signal to the bit encoder 50.

Also, an AV decoder 30 finally decodes the reproducing signal of the recording medium 10, which is transmitted from the signal processor, and provides the decoded signal to the user as output data such as video or audio signal. The AV decoder 30 can include a plurality of decoders depending on types of data.

The elements of the aforementioned data recording/reproducing apparatus according to the present invention may be implemented as either software or hardware to perform their respective functions, or software and hardware in combination.

It will be apparent to those skilled in the art that the present invention can be embodied in other specific forms without departing from the spirit and essential characteristics of the invention. Thus, the above embodiments are to be considered in all respects as illustrative and not restrictive. The scope of the invention should be determined by reasonable interpretation of the appended claims and all change which comes within the equivalent scope of the invention are included in the scope of the invention.

### Mode for the Invention

Various embodiments of the present invention have been described in detail through the best mode for carrying out the invention.

### Industrial Applicability

According to the recording medium, the data recording/reproducing method and the data recording/reproducing apparatus of the present invention, the size of the defect management information of the recording medium can be reduced. Also, since the general management information and the defect management information can be located in the recording layer together, the time for reading the defect management information can be reduced. Accordingly, the defect occurring in the recording medium can be managed more efficiently.

1. A recording medium comprising:
a data zone where user data are recorded;
an inner zone located at an inner circumference of the data zone; and
an outer zone located at an outer circumference of the data zone, wherein the data zone includes at least one spare area, and at least one of the inner zone and the outer zone includes at least one disc management area,
the disc management area including:
defect management information of the recording medium;
general management information including information of the defect management information; and
address information of the spare area that can be used as a defective replacement cluster,
the general management information including address information per cluster of the disc management area where the defect management information is recorded.

2. The recording medium of claim 1, wherein the defect management information includes a defect list entry including cluster address information of the spare area determined as a defective cluster.

3. The recording medium of claim 1, wherein the address information of the spare area that can be used as a defective replacement cluster is recorded in a header of the defect management information.

4. The recording medium of claim 1, wherein the address information of the spare area that can be used as a defective replacement cluster is recorded in the general management information.

5. The recording medium of claim 1, wherein the address information of the spare area that can be used as a defective replacement cluster includes cluster address information per spare area.

6. The recording medium of claim 1, wherein the address information of the spare area that can be used as a defective replacement cluster includes cluster address information of one spare area.

7. The recording medium of claim 1, wherein the address information is a physical sector number (PSN).

8. The recording medium of claim 1, wherein the recording medium is a re-recordable recording medium.

9. The recording medium of claim 1, wherein the recording medium includes three or more recording layers.

10. A data recording method comprising:
recording address information of a spare area of a recording medium, which can be used as a defective replacement cluster of the recording medium, in a disc management area of the recording medium; and
recording general management information in the disc management area of the recording medium, the general management information including address information per cluster of the disc management area where defect management information of the recording medium is recorded.

11. The data recording method of claim 10, wherein the defect management information includes a defect list entry including cluster address information of the spare area determined as a defective cluster.

12. The data recording method of claim 10, wherein the address information of the spare area that can be used as a defective replacement cluster is recorded in a header of the defect management information.

13. The data recording method of claim 10, wherein the address information of the spare area that can be used as a defective replacement cluster is recorded in the general management information.

14. The data recording method of claim 10, wherein the recording medium comprises a plurality of spare areas, and address information of the spare area that can be used as a defective replacement cluster includes cluster address information per spare area.

15. The data recording method of claim 10, wherein the address information of the spare area that can be used as a defective replacement cluster includes cluster address information of one spare area.

16. A data reproducing method comprising:
reading address information of a spare area of a recording medium, which can be used as a defective replacement cluster of the recording medium, from at least one disc management area included in the recording medium and;
reading general management information including address information per cluster of the disc management area where defect management information of the recording medium is recorded; and
reproducing data of the recording medium based on the defect management information.

17. The data reproducing method of claim 16, wherein the defect management information includes a defect list entry including cluster address information of the spare area determined as a defective cluster.

18. The data reproducing method of claim 16, wherein the address information of the spare area that can be used as a defective replacement cluster is recorded in a header of the defect management information.

19. The data reproducing method of claim 16, wherein the address information of the spare area that can be used as a defective replacement cluster is recorded in the general management information.

20. The data reproducing method of claim 16, wherein the recording medium comprises a plurality of spare areas, and address information of the spare area that can be used as a defective replacement cluster includes cluster address information per spare area.

21. The data reproducing method of claim 16, wherein the address information of the spare area that can be used as a defective replacement cluster includes cluster address information of one spare area.

22. A data recording apparatus comprising:
a pickup configured to record data in a recording medium; and
a controller configured to control the pickup to record address information of a spare area of the recording medium, which can be used as a defective replacement cluster of the recording medium, and general management information including address information per cluster of the disc management area where defect management information of the recording medium is recorded, in a disk management area of the recording medium.

23. The data recording apparatus of claim 22, wherein the defect management information includes a defect list entry including cluster address information of the spare area determined as a defective cluster.

24. The data recording apparatus of claim 22, wherein the address information of the spare area that can be used as a defective replacement cluster is recorded in a header of the defect management information.

25. The data recording apparatus of claim 22, wherein the address information of the spare area that can be used as a defective replacement cluster is recorded in the general management information.

26. The data recording apparatus of claim 22, wherein the recording medium includes a plurality of spare areas, and the address information of the spare area that can be used as a defective replacement cluster includes cluster address information per spare area.

27. The data recording apparatus of claim 22, wherein the address information of the spare area that can be used as a defective replacement cluster includes cluster address information of one spare area.

28. A data reproducing apparatus comprising:
a pickup configured to read data from a recording medium; and
a controller configured to control the pickup to:
read address information of a spare area of the recording medium, which is recorded in at least one disc management area included in the recording medium and can be used as a defective replacement cluster of the recording medium,
read general management information including address information per cluster of the disc management area where defect management information of the recording medium is recorded, and
reproduce data of the recording medium based on the defect management information.

29. The data reproducing apparatus of claim 28, wherein the defect management information includes a defect list entry where cluster address information of the spare area determined as a defective cluster is recorded.

30. The data reproducing apparatus of claim 28, wherein the address information of the spare area that can be used as a defective replacement cluster is recorded in a header of the defect management information.

31. The data reproducing apparatus of claim 28, wherein the address information of the spare area that can be used as a defective replacement cluster is recorded in the general management information.

32. The data reproducing apparatus of claim 28, wherein the recording medium includes a plurality of spare areas, and the address information of the spare area that can be used as a defective replacement cluster includes cluster address information per spare area.

33. The data reproducing apparatus of claim 28, wherein the address information of the spare area that can be used as a defective replacement cluster includes cluster address information of one spare area.
